(19) United States
(12) Patent Application Publication
(10) Pub. No.: US 2016/0108797 A1
(43) Pub. Date: Apr. 21, 2016

(54) THERMOSTAT

(71) Applicant: INTERNATIONAL ENGINE INTELLECTUAL PROPERTY COMPANY, LLC, Lisle, IL (US)

(72) Inventor: Christofer J. Palumbo, Elmwood Park, IL (US)

(73) Assignee: International Engine Intellectual Property Company, LLC, Lisle, IL (US)

(21) Appl. No.: 14/893,409

(22) PCT Filed: May 29, 2013
(86) PCT No.: PCT/US13/42962

§ 371 Date: Nov. 23, 2015

(51) Int. Cl. F01P 7/16; G05D 23/02

(52) U.S. Cl. CPC F01P 7/165; G05D 23/022

(57) ABSTRACT

A thermostat for controlling the flow of a coolant into a radiator and a bypass circuit is provided. When the bypass circuit is to be closed, the thermostat displaces a shaft that is operably attached to a bypass plate. When in the closed position, the bypass plate is configured to engage a top wall of the bypass circuit so as to prevent the flow of coolant into the bypass circuit. To minimize the formation of a water pressure pulses generated by the closing of the bypass circuit, only a portion of the bypass plate initially contacts the top wall. Such limited contact allows for the restriction of the flow of coolant into the bypass circuit, and interrupts the even flow of coolant around the bypass plate. Such restriction and/or interruption allows for the gradual closing of the bypass circuit, which minimizes the associated water hammer effect.

### BACKGROUND

A thermostat may be employed in coolant systems to at least assist in controlling the temperature of a coolant in a coolant system that at least assists in controlling the temperature or cooling other systems or components. Moreover, coolant systems, such as, for example, those used with internal combustion engines, may use and control the flow of a coolant, such as a fluid, that absorbs and removes heat from the surrounding environment or components, such as other engine components. The heated fluid may then be delivered to a heat exchanger, such as, for example, a radiator, to ultimately transfer heat from the heated fluid to ambient air. In certain types of coolant systems, the coolant employed by the coolant system is a liquid, such as, for example, a water-based coolant that includes glycols and additives that seek to limit corrosion, cavitation, and/or erosion, and which is commonly referred to as antifreeze.

The path fluid, such as coolant, takes in the coolant system may be controlled, at least in part, by a thermostat. More specifically, coolant in the cooling system may be allowed to flow through a primary heat exchanger, such as a radiator, or bypass the radiator by flowing through a bypass circuit. The thermostat may be configured to control whether coolant is directed toward the radiator or the bypass circuit. More specifically, when coolant is at a low temperature, the thermostat may be in a closed position such that flow path for coolant to the primary heat changer or radiator is closed, while the flow path to the bypass circuit is open. Thus, when the thermostat is in the closed position, a bypass plate that is operably connected to the thermostat may be in an open position, wherein the bypass plate is positioned away from an opening of a bypass circuit. When the bypass plate is in its open position, at least a portion of coolant is diverted into the bypass circuit rather than flowing into the primary heat changer. As the temperature of the engine, and thus the temperature of the coolant, begins to increase, the thermostat is transitioned towards its open position such that the bypass plate moves closer towards the opening of the bypass circuit, and thus closer to the closed position of the bypass plate. When the thermostat reaches its fully open position, the flow path for coolant to the primary heat changer is fully opened so that coolant is directed into the primary heat changer, while the flow path to the bypass circuit is closed.

During operation of the thermostat, as the bypass plate moves closer to the bypass plate's closed position, the velocity of the coolant flowing around the bypass plate and into the bypass circuit may be elevated, such as, for example, in accordance with the Bernoulli Principle. Such relatively high velocities and even flow of coolant around the bypass plate and into bypass circuit may create a low pressure at the bypass plate or between the bypass plate and an opening to the bypass circuit. Such pressures may result in the formation of a suction force that forces the bypass plate to rapidly close the opening to the bypass circuit, and thereby suddenly terminate the relatively high flow velocity of the coolant into the bypass circuit.

Such abrupt stoppage of the relatively high velocity flow of coolant into the bypass circuit may result in a hammer effect, such as water or fluid hammer effect. Such a hammer effect results in relatively high coolant pressure pulses across the coolant system that can damage a variety of different components in the coolant system.

With the stoppage of the high velocity flow of coolant pass the bypass plate, the suction previously used to close the bypass plate may be removed. Accordingly, a spring used by the thermostat may be employed to displace the bypass plate back to the open position of the bypass plate. However, the bypass plate may be repeatedly displaced between opened and closed positions during the operation of the coolant system, which may again result in subsequent and repeated hammer effects caused by the rapid closing of the bypass circuit.

### SUMMARY

According to certain embodiments, a thermostat is provided for controlling the flow of a coolant into a radiator and a bypass circuit. The thermostat includes a housing having a shaft and a spring. The shaft is configured to extend away from the housing from an open position to a closed position as a temperature of the thermostat increases. The thermostat also includes a bypass plate that is operably secured to the shaft. The bypass plate has an outer surface and a central longitudinal axis. The outer surface is configured to abut against a top wall of the bypass circuit to prevent the flow of coolant into an opening of the bypass circuit when the shaft is in the closed position. The central longitudinal axis of the bypass plate is not parallel to a central longitudinal axis of the housing as the shaft is displaced from the open position and toward the closed position.

According to another embodiment, a thermostat is provided for controlling the flow of a coolant into a radiator and a bypass circuit. The thermostat includes a housing having an inner housing, a shaft, and a spring. The shaft is configured to extend away from the inner housing from an open position to a closed position as a temperature of the coolant increases. The thermostat also includes a bypass plate that is operably secured to the shaft. The bypass plate has an outer surface that is configured to abut against a top wall of the bypass circuit to prevent the flow of coolant into an opening of the bypass circuit when the shaft is in the closed position. The thermostat is also configured for the outer surface of the bypass plate to not be parallel to the top wall as the shaft is displaced from the open position and toward the closed position.

Additionally, according to another embodiment, a method for the closing of a bypass circuit in a cooling system is provided. The method includes displacing a shaft of a thermostat from an open position to a closed position. The shaft is operably connected to a bypass plate. The method also includes contacting, while the shaft is being displaced toward the closed position, only a portion of an outer surface of the bypass plate with a top wall of the bypass circuit such that the outer surface is not parallel to the top wall. The top wall of the bypass circuit has an opening that is configured for the passage of a coolant into the bypass circuit. Additionally, the bypass plate is tilted so that the outer surface of the bypass plate and the top wall of the bypass circuit form a seal about the opening that prevents the flow of the coolant into the bypass circuit.

### BRIEF DESCRIPTION OF THE DRAWINGS

FIG. 1 illustrates a side cross sectional view of a thermostat with the bypass plate in the open position.

FIG. 2 illustrates a side cross sectional view of the thermostat of FIG. 1 with the tilted bypass plate nearing the closed position.

FIG. 3 illustrates a side cross sectional view of the thermostat of FIG. 1 with the bypass plate in the closed position.

FIG. 4 illustrates a side cross sectional view of the thermostat that includes a shoulder that is configured to at least assist in tilting the orientation of the bypass plate as the bypass plate moves from an open position toward a closed position.

FIG. 5 illustrates a side cross sectional view of a thermostat with the bypass plate in the open position and a top wall of an opening to the bypass circuit being nonparallel to the bypass plate.

FIG. 6 illustrates a front view of a portion of the shaft and the bypass plate taken along line A-A in FIG. 1.

FIG. 7 shows a graph of testing data illustrating the hammer effect generated by the closing of the bypass plate on a commercially available 1-6 thermostat.

FIG. 8 shows a graph of testing data illustrating the hammer effect generated by the closing of the bypass plate of embodiments of thermostat discussed with respect to FIGS. 1-3.

### DETAILED DESCRIPTION

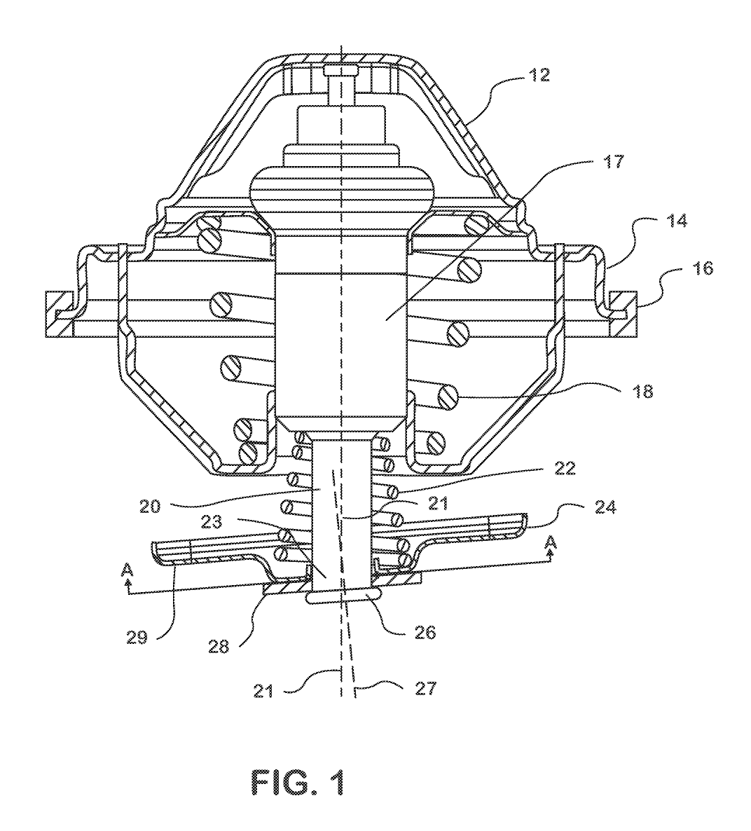

FIGS. 1-5 illustrate side cross sectional views of a thermostat 10, 10′, 10″ according to illustrated embodiments with a bypass plate 24 in open, nearly closed, and closed positions, respectively. For purposes of illustration, the motion of other thermostat 10, 10′, 10″ components that occur as the temperature of the coolant fluid and thermostat 10, 10′, 10″ increases is not shown.

As shown in FIGS. 1-4, the thermostat 10, 10′ may include a housing 12, cup 14, an inner housing 17, a shaft 20, an internal spring 18, bypass plate 24, and a stopper 26. The thermostat 10, 10′, 10″ may be operably secured in the coolant system, at least a portion of the thermostat 10, 10′, 10″ being exposed to the flowing fluid, such as liquid coolant, in the coolant system. According to certain embodiments, the thermostat 10, 10′, 10″ may include an outer seal 16 that is configured to prevent the undesirable flow of coolant out of the coolant system at or around the location of where the thermostat 10, 10′, 10″ is secured to the coolant system.

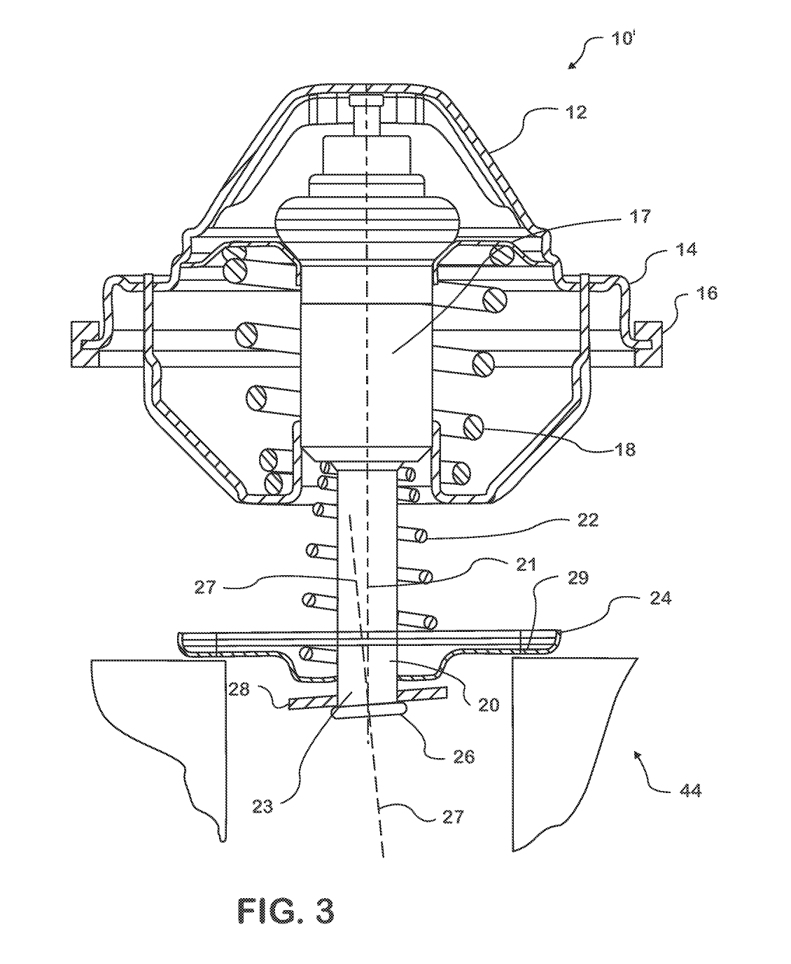

According to certain embodiments, the inner housing 17 may house or contain wax that expands as the temperature of the coolant about the thermostat 10, 10′, 10″ increases, and thus due to the resulting increase in the temperature of thermostat 10, 10′, 10″. As the wax expands, the shaft 20 may begin to be pushed away from the inner housing 17 such that the shaft 20 extends further out of the inner housing 17. Moreover, the shaft 20 may be in a telescoping arrangement with the inner housing 17 such that as the temperature of the thermostat 10, 10′, 10″ increases, the shaft 20 extends further out of and away from the inner housing 17. The shaft 20 may continue to extend out of the inner housing 17 as the temperature of the thermostat 10, 10′, 10″ is increasingly elevated by the heated temperature of the fluid flowing in the coolant system such that the bypass plate 24 reaches a position that closes a bypass circuit 44, as shown in FIG. 3.

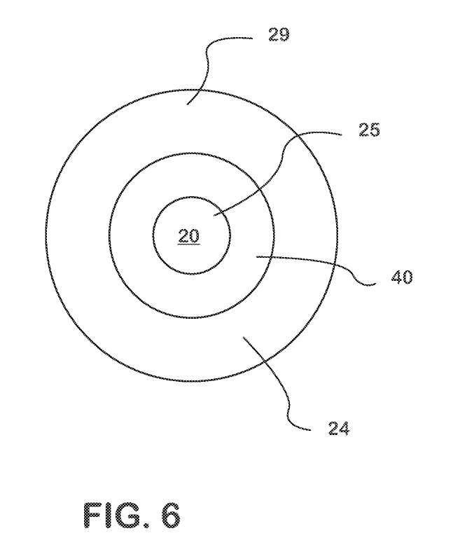

The bypass plate 24 is operably attached to the shaft 20. The shaft may be configured to allow for the slidable movement of the bypass plate 24 along at least a portion of the shaft 20. Moreover, the bypass plate 24 may include an aperture 25, as shown in FIG. 6, having an inner diameter that is larger than the diameter of at least a portion of the shaft 20. Such differences in diameters allow the bypass plate 24 to slide along at least a portion of the of the shaft 20, such as when the bypass plate 24 reaches a closed position against a top wall 42 of the bypass circuit 44 while the shaft 20 continues to extend away from the inner housing 17. Additionally, such differences in diameters may also allow for a degree of angular displacement of the bypass plate 24 relative to the central longitudinal axis 21 of the inner housing 17. According to certain embodiments, the shaft 20, or portions of the shaft 20, may have a central longitudinal axis that is the same as the central longitudinal axis 21 of the inner housing 17.

Referencing FIGS. 1-3, according to illustrated embodiments, the bypass plate 24 may be positioned on the shaft 20 between the shoulder 38 and the stopper 26. The stopper 26 may be positioned on a distal end 23 of the shaft 20. The stopper 26 may be provided by a variety of different components and/or have a variety of different configurations. For example, according to certain embodiments, the stopper 26 may be a rivet, bolt, pin, or flange, among others. Further, according to certain embodiments, the bypass plate 24 may be biased against or toward the stopper 24 by a spring 22.

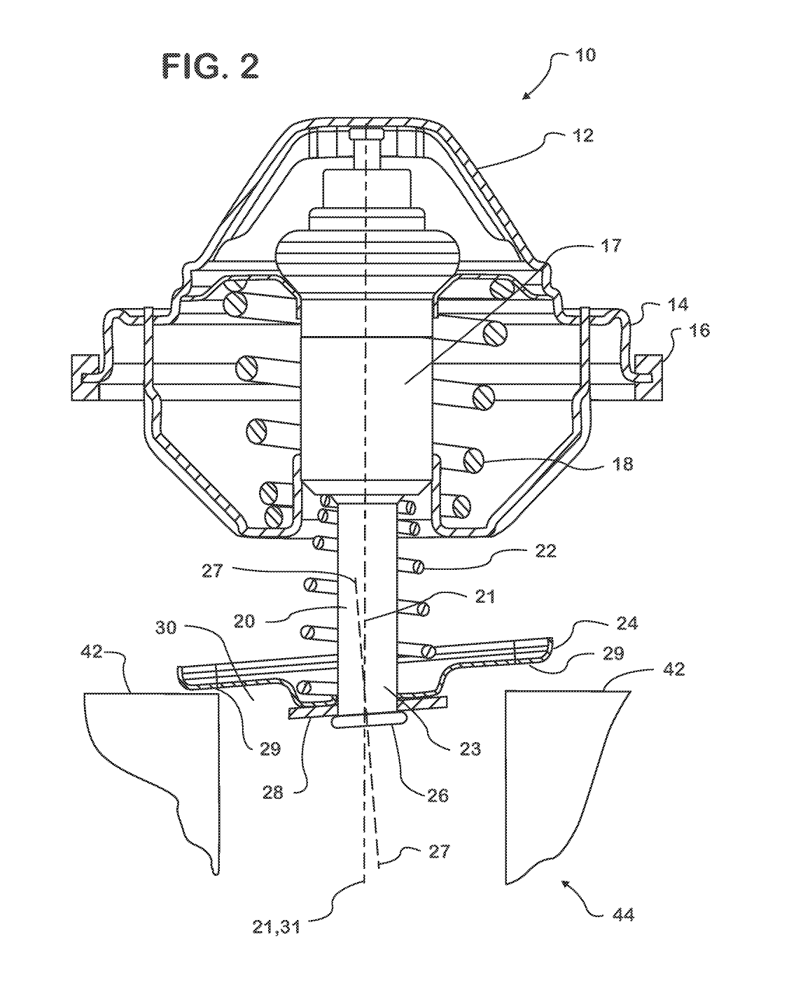

FIG. 1 illustrates the thermostat 10 with the bypass plate 24 in the open position. As shown, the stopper 26 at the distal end 23 of the shaft 20 is in relative close proximity to the housing 12. However, as shown in FIG. 2, as the temperature of the thermostat 10 increases, in the illustrated embodiment the wax within the cup 14 expands, the shaft 20 extends further out of the inner housing 17 and away from the housing 12. The bypass plate 24 is also pushed further away from the housing 12 with the shaft 24, such as by the biasing force of the spring 22.

As shown in FIG. 3, the bypass plate 24 is configured to, when in a closed position, prevent the flow of fluid into the opening 30 of a bypass circuit 44. The opening 30 may be positioned about a top wall 42 of the bypass circuit 44. Accordingly, the bypass plate 24 may include an outer surface 29 that, when abutted against the top wall 42, at least assists in providing a sealing engagement between the bypass plate 24 and the top wall 42 that prevents the flow of fluid into the bypass circuit 44. When the bypass plate 24 is in the closed position, the spring 22 may bias the bypass plate 24 against the top wall 24.

Additionally, according to certain embodiments, the opening 30 of the bypass circuit 44 may have a central longitudinal axis 31 that is generally parallel to the central longitudinal axis 21 of at least a portion of the housing 12, inner housing 17 and/or shaft 20. According to certain embodiments, when assembled as a thermostat, the housing 12, inner housing 17 and/or shaft 20 may generally share a central longitudinal axis 21. Further, according to certain embodiments, the central longitudinal axis 31 of the opening 30 may also be perpendicular to the top wall 42 of the bypass circuit 44.

As illustrated in FIG. 2, the thermostat 10 may be configured such that the outer wall 29 of the bypass plate 24 is non-parallel to the top surface 42 and/or opening 30 of the bypass circuit 44 as the bypass plate 24 approaches its closed position. For example, according to certain embodiments, the stopper 26 may have a central longitudinal axis 27 that is non-parallel to, and angularly offset from, the central longitudinal axis 21 of at least a portion of the shaft 20 and/or of the inner housing 17. Accordingly, as shown in, for example, FIGS. 2 and 3, the stopper 26 may appear to be bent or tilted such that the central axis 27 of the stopper 26 intersects the central longitudinal axis 21 of the shaft 20 and/or of the inner housing 17 at an acute angle greater than 0°. As the bypass plate 24 may be biased against the stopper 24 by the spring 22, the bypass plate 24 and the stopper 24 may generally share the same central longitudinal axis 27 as the bypass plate 24 is moved toward the closed position. Further, when the bypass plate 24 is pressed toward or against the stopper 26, the angular offsetting of the stopper 26 relative to at least the central longitudinal axis 27 of the inner housing 17, shaft 20, and/or of the opening 30 allows the bypass plate 24 to approach the top surface 42 in a tilted position in which the outer surface 29 of the bypass plate 24 is not parallel to the top wall 42. Accordingly, as shown in FIG. 2, when the bypass plate 24 does initially come into contact with the top wall 42, only a portion of an outer surface 29 of the bypass plate 24 is in contact with the top wall 42, as shown in FIG. 2.

Such limited initial contact of the outer surface 29 with the top wall 42 may restrict, but not terminate, the flow of fluid into the opening 30. Moreover, such tilting of the bypass plate 24 may allow for a relatively gradual covering the opening 30 as the shaft 20 continues to be displaced away from the thermostat 10 and/or an interruption of the even flow of fluid passing around the bypass plate 24 and entering into the opening 30. By gradually reducing the flow and/or interrupting the even flow around the bypass plate 24, the sudden termination in the flow of a larger quantity of the coolant into the bypass circuit 44, resulting in the hammer effect experienced by the coolant system when the bypass plate 24 reaches its fully closed position is reduced.

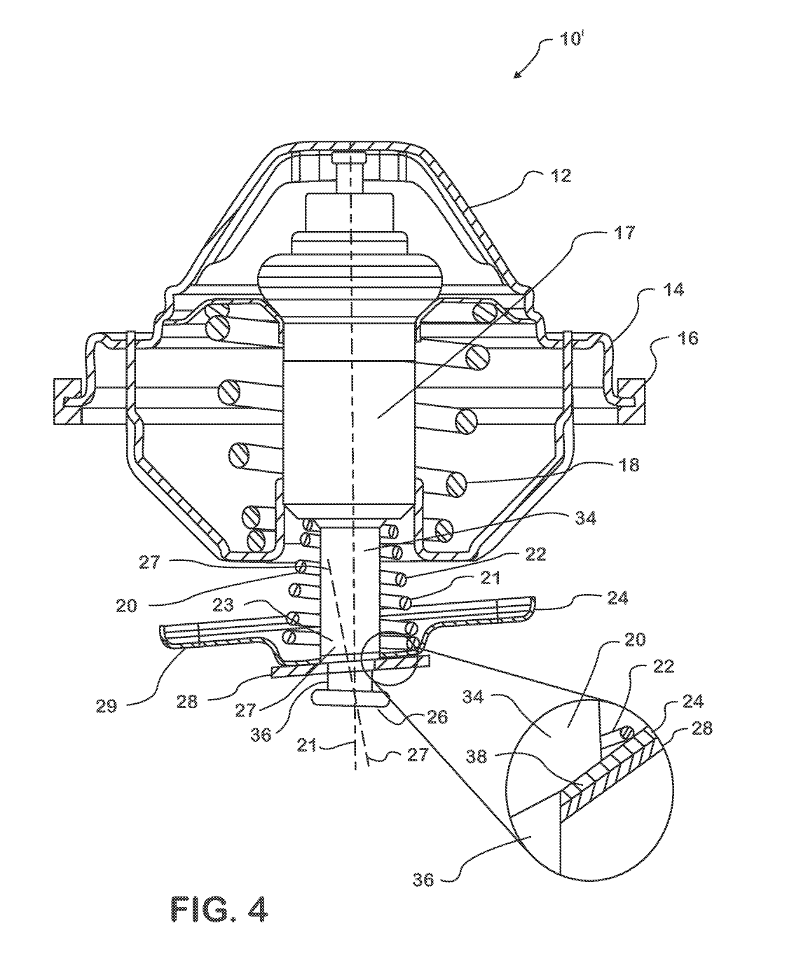

Referencing FIG. 4, according to other embodiments, the shaft 20 may include a shoulder 38 that is used tilt the positioning of the bypass plate 24 as the bypass plate 24 approaches the closed position so that the outer surface 29 of the bypass plate 24 initially has limited contact with the top wall 42 that restricts, but does not immediately terminate, the flow of fluid into the opening 30. For example, the shoulder 38 may be provided by differences in diameters between first and second portions 34, 36 of the shaft 20, with the bypass plate 24 being positioned about a smaller shaft 20, such as for example the second portion 36 in FIG. 4. Such differences in shaft 20 diameters may provide the shoulder 38 against which a portion of the bypass plate 24, such as the rear side of a hub 40 in the illustrated embodiment, abuts as the bypass plate 24 is moved toward the closed position. Additionally, the shoulder 38 may be configured to be tilted such that the longitudinal axis 21 or the longitudinal axis 31 of the opening 30 intersects the bypass plate 24 at an acute angle greater than 0 degrees. Such tilted configuration of the shoulder 38 may thereby allow for the bypass plate 24 to be in a similar tilted position as the bypass plate 24 moves toward the closed position, and thereby allow for limited initial contact of the outer surface 29 of the bypass plate 24 with the top wall 42 so as to initially restrict, but not terminate, the flow of fluid into the opening 30. Such tilting of the bypass plate 24 may, again, allow for a relatively gradual closing of the opening 30 as the shaft 20 continues to be displaced away from the thermostat 10′ and/or an interruption of the even flow of fluid passing around the bypass plate 24 and entering into the opening 30.

Additionally, according to other embodiments, the second portion 36 of the shaft 20 of the thermostat 10′, along which the bypass plate 24 may be positioned, may also have a central longitudinal axis 27 that is similar to that illustrated for the stopper 26 so that the central longitudinal axis 27 of the second portion 36 and bypass plate 24 are non-parallel to, and angularly offset from, the central longitudinal axis 31 of the opening 30, not perpendicular to the top wall 42 of the bypass circuit 44, and/or angularly offset from the central longitudinal axis 21 of the shaft 17. Such an offset may again allow the bypass plate 24 to be in a tilted position as the bypass plate 24 initially engages the top wall 42 so that, only a portion of the outer surface 29 of the opening 30 contacts the top wall 42 of the bypass circuit 44 so that the opening 30 may be gradually closed and the even flow of the coolant around the bypass plate 24 is interrupted.

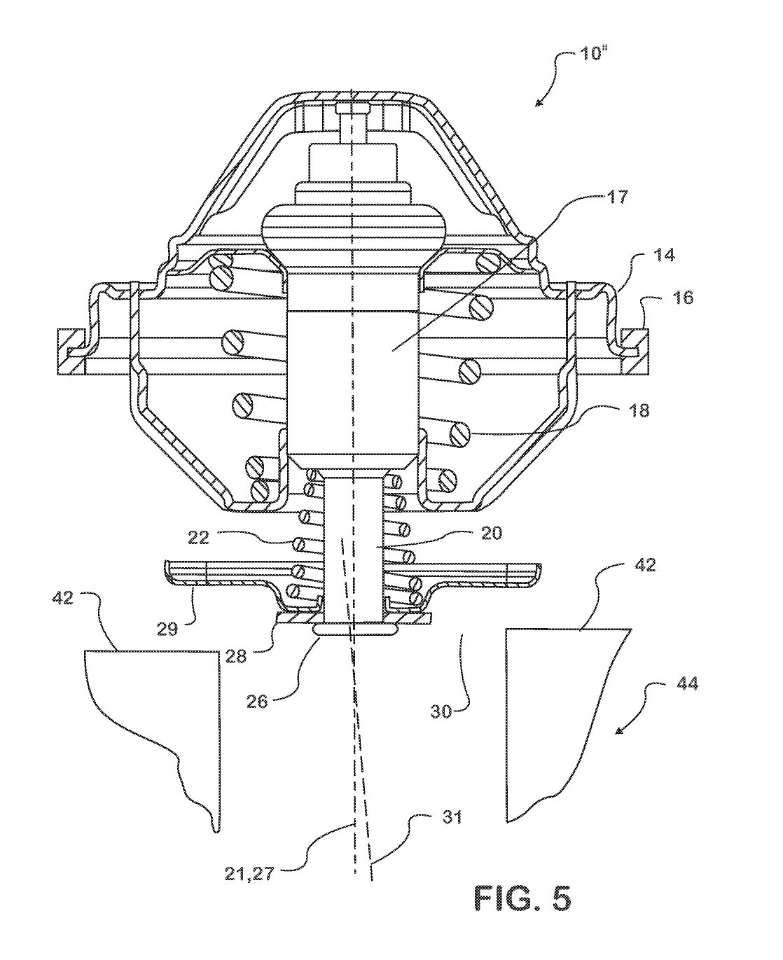

Referencing FIG. 5, according to other embodiments, the top wall 42 of the bypass circuit 44 may be configured to be non-parallel to the bypass plate 24 as the bypass plate 24 is moved toward the closed position. More specifically, the top wall 42 may be configured to be non-parallel to the surface of the bypass plate 24 that will eventually abut against the top wall, such as the outer surface 29 of the bypass plate 24. Such a non-parallel orientation may also allow for limited initial contact of the outer surface 29 of the bypass plate 24 with the top wall 42 so as to initially restrict, but not terminate, the flow of fluid into the opening 30. Such tilting of the bypass plate 24 may, again, allow for a relatively gradual closing of the opening 30 as the shaft 20 continues to be displaced away from the thermostat 10′ and/or an interruption of the even flow of fluid passing around the bypass plate 24 and entering into the opening 30.

With the embodiments discussed with respect to FIGS. 1-5, after initial contact of the bypass plate 24 with the top wall 42, the shaft 20 continues to be displaced so that the portions of the outer surface 29 that coming into contact with the top wall 42 continue to increase, causing the flow of fluid through the opening 30 continue to be further restricted and/or interrupted. Such continued restriction of flow through the opening 30 continues the relative gradual closing of the opening 30 until the outer surface 29 is positioned to completely close the opening 30, as shown, for example, in FIG. 3. Further, the spring 22 presses upon the bypass plate 24 to ensure that the bypass plate 24 is properly position in the opening 30 and/or against the top wall 42 so that the bypass plate 24 closes the opening 30. Moreover, the spring 22 may ensure that the outer surface 29 is eventually parallel to, and abuts against, the top wall 42 adjacent to the opening 30 so as to provide a seal that prevents the flow of fluid, such as liquid coolant, through the opening 30 and into the bypass circuit 44.

After the opening 30 of the bypass circuit 44 has been closed, the internal spring 18 that is operably connected to the bypass plate 24 and/or to the shaft 20 may force the displacement of the bypass plate 24 to move away from the opening 30 and back to an open position. According to certain embodiments, a washer 28 may positioned between the stopper 26 and the bypass plate 24 that assists in at least preventing the stopper 26 from being pulled into or through the aperture 32, and/or for the distribution of forces associated with the stopper 26 abutting against the bypass plate 24 as the bypass plate 24 is displaced back to the open position. The above closing and opening of the bypass plate 24 may then be continuously repeated during operation of the coolant system.

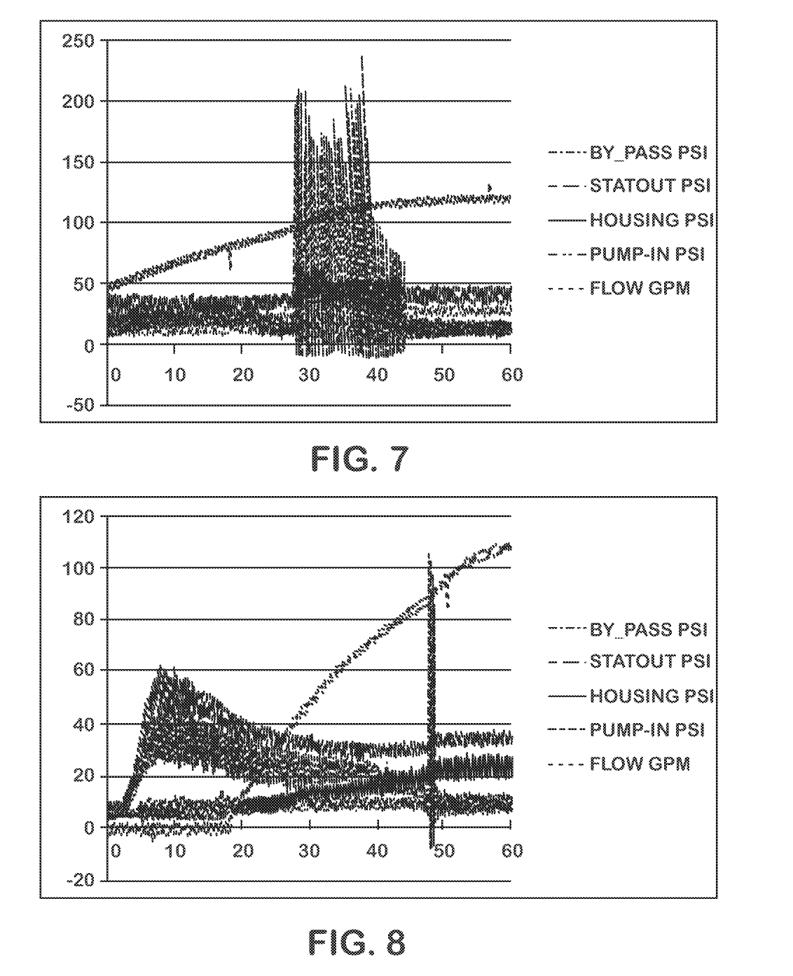

FIGS. 7 and 8 provide tables plotting pressure (psi) over time to demonstrate the effects of the gradual closing of the opening 30 of the bypass circuit 44 by allowing for a comparison of the effects the use of a commercial 1-6 thermostat (FIG. 7) and a thermostat 10 configuration as shown in FIGS. 1-3 (FIG. 8) in a diesel internal combustion engine used for automobile applications have on the hammer effects in the coolant system. The “FLOW GPM” shown in FIGS. 7 and 8 was the flow (gallons per minute) of a water based coolant containing typical additives used in automotive applications (commonly referred to as antifreeze) as measured at the inlet of a radiator. “PUMP-IN PSI” demonstrates the pressure per square inch (psi) of coolant that has exited the radiator and is about to enter the inlet of the water pump of the coolant system. The thermostat 10 is positioned on the opposite side, or inlet side, of the radiator. “HOUSING PSI” was a measurement of the pressure per square inch of coolant in the crankcase of the engine. “STATOUT PSI” was the measured pressure per square inch of coolant passing the thermostat 10 and entering the inlet of the radiator. Additionally, “BY_PASS PSI” was the measured pressure per square inch of coolant within the bypass circuit 44 at or near the opening 30.

In FIG. 7, using a commercially available 1-6 thermostat in which the flow of a relatively large quantity of coolant into the bypass circuit 44 was suddenly terminated by a bypass plate closing the opening 30, a relatively large hammer effect was experienced by the coolant system. Specifically, as demonstrated by FIG. 7, a spike in pressure was recorded as starting at approximately the 27 second marker and continuing for approximately the next 17 seconds, or until approximately the 44 second marker. Further, during this time, the hammer effect was evidenced by, for example, the coolant pressure experienced at or near the opening 30 in the bypass circuit 44 exceeding 200 psi at some spikes, the coolant pressure at the radiator inlet being around 50 psi, and the pressure at the crankcase and outlet of the radiator being slightly below 50 psi.

Conversely, referencing FIG. 8, conducting the same test as shown in FIG. 7 with a 1-6 thermostat that was modified to have a bent or tilted stopper 26 in accordance with the thermostat 10 of FIGS. 1-3 so that the opening 30 of the bypass circuit 44 is gradually closed, and even flow around the bypass plate 24 was interrupted, demonstrated a relatively significant reduction in the time of the hammer effect as well as a reduction in the coolant pressure spikes associated with the hammer effect. Specifically, as shown in FIG. 8, the hammer effect that was recorded as occurring at approximately the 48 second marker lasted for approximately 1 second. Additionally, unlike the 200 psi spike peak seen in FIG. 7 at or near the opening 30 of the bypass circuit 44, using the modified thermostat 10′ of FIG. 4 provided a peak psi at the same location that slightly exceeded 100 psi. Similarly, comparing FIGS. 7 and 8, the “PUMP-IN PSI,” “HOUSING PSI,” and “STATOUT PSI” measured during the hammer effect shown in FIG. 7 is generally about twice as large as the same measurements recorded using the thermostat 10 of FIGS. 1-3. Such reduction in pressures, as well as the significant reduction in the duration of the hammer effect demonstrates that, using a thermostat 10 as discussed above in connection with FIGS. 1-3 in the coolant system reduces high coolant pressure pulses associated with the closing of the bypass circuit 44 and that otherwise can damage components of the coolant system, including, for example, causing damage to the thermostat.

1. A thermostat for controlling the flow of a coolant into a radiator and a bypass circuit, the thermostat comprising:
a housing having a shaft and a spring, the shaft configured to extend away from the housing from an open position to a closed position as a temperature of the thermostat increases;
a bypass plate operably secured to the shaft, the bypass plate having an outer surface and a central longitudinal axis, the outer surface configured to abut against a top wall of the bypass circuit to prevent the flow of coolant into an opening of the bypass circuit when the shaft is in the closed position, the central longitudinal axis of the bypass plate not being parallel to a central longitudinal axis of the housing as the shaft is displaced from the open position and toward the closed position.

2. The thermostat of claim 1, further including a stopper, the spring configured to bias the bypass plate toward the stopper, the stopper having a central longitudinal axis that is not parallel to the central longitudinal axis of the shaft.

3. The thermostat of claim 1, wherein the bypass plate is positioned about a portion of the shaft having a central longitudinal axis that is not parallel to the central longitudinal axis of the housing.

4. The thermostat of claim 1, wherein the shaft includes a shoulder portion that has a surface that is not perpendicular to the central longitudinal axis of the housing, the shaft configured for at least a portion of the bypass plate to abut against the shoulder as the bypass plate is displaced from the open position and toward the closed position.

5. The thermostat of claim 1, wherein the bypass plate includes an outer surface that is configured to be non-parallel to a top wall of the bypass circuit as the bypass plate moves toward the closed position.

6. The thermostat of claim 5, wherein the spring is configured to bias the outer surface of the bypass plate against the top wall of bypass circuit when the shaft is in the closed position.

7. A thermostat for controlling the flow of a coolant to a radiator and a bypass circuit, the thermostat comprising:
a housing having an inner housing, a shaft, and a spring, the shaft configured to extend away from the inner housing from an open position to a closed position;
a bypass plate operably secured to the shaft, the bypass plate having an outer surface, the outer surface configured to abut against a top wall of the bypass circuit to prevent the flow of coolant into an opening of the bypass circuit when the shaft is in the closed position, the thermostat configured for the outer surface of the bypass plate to not be parallel to the top wall as the shaft is displaced from the open position and toward the closed position.

8. The thermostat of claim 7, further including a stopper configured to at least assist in securing the bypass plate to the shaft, the stopper further configured to at least assist in positioning the bypass plate in a non-parallel alignment with the top wall of the bypass circuit as the shaft is displaced from the open position and toward the closed position.

9. The thermostat of claim 7, wherein at least a portion of the shaft is configured to position the bypass plate is in a non-parallel alignment with the top wall of the bypass circuit as the shaft is displaced from the open position and toward the closed position.

10. The thermostat of claim 7, wherein the shaft includes a shoulder, the shaft configured to allow at least a portion of the bypass plate to abut against the shoulder as the shaft is displaced from the open position and toward the closed position, the shoulder having a surface that is not parallel to the top wall of the bypass circuit such that the bypass plate is in a non-parallel alignment with the top wall of the bypass circuit as the shaft is displaced from the open position and toward the closed position.

11. A method of closing a bypass circuit in a cooling system, the method comprising:
displacing a shaft of a thermostat from an open position to a closed position, the shaft being operably connected to a bypass plate;
contacting, while the shaft is being displaced toward the closed position, only a portion of an outer surface of the bypass plate with a top wall of the bypass circuit such that the outer surface is not parallel to the top wall, the top wall having an opening that is configured for the passage of a coolant into the bypass circuit; and
tilting the bypass plate so that the outer surface and the top wall to form a seal about the opening that prevents the flow of the coolant into the bypass circuit.

12. The method of claim 11, further wherein the step of contacting only a portion of the outer surface with the top wall further includes interrupting an even flow of the coolant around the bypass plate and into the opening.

13. The method of claim 12, further including biasing the outer surface against the top wall when the shaft is in the closed position.

14. The method of claim 13, further including abutting the bypass plate against a shoulder of the shaft as the shaft is displaced toward the closed position, the shoulder being configured to position the bypass plate so that the outer surface is not parallel to the top wall as the shaft is displaced toward the closed position.

15. The method of claim 13, further including abutting the bypass plate against a stopper of the shaft as the shaft is displaced toward the closed position, the stopper configured to at least assist in retaining the bypass plate on the shaft, the stopper also configured to position the bypass plate so that the outer surface is not parallel to the top wall as the shaft is displaced toward the closed position.
